(19) United States
(12) Patent Application Publication
(10) Pub. No.: US 2002/0111149 A1
(43) Pub. Date: Aug. 15, 2002

(54) Vehicle antenna apparatus

(76) Inventor: Hiroki Shoki, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/062,466

(22) Filed: Feb. 5, 2002

(30) Foreign Application Priority Data
Feb. 9, 2001 (JP) 2001-034346

(51) Int. Cl. H04B 1/06

(52) U.S. Cl. 455/277.1; 455/277.2

(57) ABSTRACT

The following are provided a plurality of antennas provided- correspondingly to a plurality of radio communication systems, a plurality of processing circuits whose one ends are connected to the antennas to apply processings including amplification and frequency conversion to signals received from a corresponding antenna input to the above one ends or signals to be transmitted to a corresponding antenna input to the other ends of the circuits, an input/ output terminal which outputs a reception signal to an external unit or inputs a transmission signal from the external unit, and a unit connected between the processing circuits and the input/output terminal to couple reception signals output from the processing circuits or distribute transmission signals input from the input/output terminal to the processing circuits.

### CROSS-REFERENCE TO RELATED APPLICATIONS

This application is based upon and claims the benefit of priority from the prior Japanese Patent Application No. 2001-034346, filed Feb. 9, 2001, the entire contents of which are incorporated herein by reference.

### BACKGROUND OF THE INVENTION

1. Field of the Invention

The present invention relates to a vehicle antenna apparatus corresponding to a plurality of radio communication systems different from each other in frequency, modulation method, access method, and the like.

2. Description of the Related Art

Because radio communication has advanced in recent years, various radio communication systems are developed and used. For example, only in rough consideration, there are services such as mobile communication and satellite communication in addition to television broadcasting. Also various communication systems are used for each service. The radio sound broadcasting includes AM (Amplitude Modulation) broadcasting, FM (Frequency Modulation) broadcasting, and short-wave broadcasting and the television broadcasting includes conventional broadcasting using a VHF (Very High Frequency) band or UHF (Ultra-High Frequency) band, satellite broadcasting, and digital broadcasting recently watched. In the case of the mobile communication, systems using different frequencies such as 800-MHz band, 1.5-GHz band, and 2-GHz band are used and moreover, systems different from each other in modulation method or access method are used.

At present, to receive various services of these different radio systems, a transceiver is necessary for every radio communication system. Therefore, to receive a plurality of services, it is necessary to prepare many transceivers. To receive these services in a home or office, it is sufficient to set these transceivers in the home or office. However, the request for receiving a plurality of attractive services “whenever” and “anywhere” has been raised.

Because portable transceivers (terminals) are limited, a user cannot obtain a sufficient satisfactory. The same is true for communication in a movable body such as an automobile, train, or ship. A user desires that services same as those that can be received in a home or office can be also received in a movable body. However, preparing a transceiver every different service in a movable body has a problem from viewpoints of setting hardware and costs and therefore, it is considerably difficult to realize a comfortable communication environment in a movable body.

As a method for solving the above problem, there is a software defined radio technique. The software defined radio technique realizes control and handling of a radio set which have been realized so far by a dedicated device in an analog-signal area by software in a digital-signal area and the radio set is referred to as a software radio set. It can be said that the software radio set will be soon practically used in accordance with the recent advancement of a digital-signal processor and an A/D converter. By using the software radio set, it is possible to flexibly correspond to a plurality of different radio communication systems by only one radio set.

As described above, though the software radio technique advances, it is necessary to set an antenna to each of radio communication systems different from each other in frequency because it is limited to widen the bandwidth of the frequency characteristic of an antenna. It is necessary that an antenna is set in a spatially-open state in order to transceive radio waves. Therefore, an antenna-setting place is restricted. For example, it is a present state that various antennas are set on an automobile in which a setting space is limited while having difficulty by forming an AM/FM-radio-broadcasting antenna into the extending type to set the antenna to the side of the driver's seat, setting a ground-wave-television-broadcasting-receiving antenna in a rear window, and setting a GPS (Global Positioning System) antenna in the back of the dashboard.

Moreover, because the number of new services is increased in future, there is a request for additionally mounting the following antennas on an automobile: antenna for ETC (Electric Toll Collection) system, antenna for inter-roadway communication system used in ITS service, antenna for portable telephone, antenna for receiving satellite digital broadcasting, and antenna for radar used for preventing collision or the like. However, there are problems that there are few spaces in which antennas can be set and antennas cannot be arranged by protruding them from a vehicle. Therefore, it can be said that it is difficult to realize a comfortable multimedia communication environment in an automobile at present.

### BRIEF SUMMARY OF THE INVENTION

It is an object of the present invention to provide a vehicle antenna apparatus that can correspond to a plurality of radio communication systems and can be easily set to a vehicle.

According to a first aspect of the present invention, a vehicle antenna apparatus capable of corresponding to a plurality of radio communication systems comprises: a plurality of antennas provided correspondingly to the radio communication systems; a plurality of processing circuits whose one ends are connected to the antennas and which apply processings including amplification and frequency conversion to reception signals sent from a corresponding antenna and input to the one ends of the circuits or transmission signals input to the other ends of the circuits and to be sent to a corresponding antenna; at least one external connector configured to output a reception signal to an external unit or inputs a transmission signal from the external unit; and a unit connected between the other ends of the processing circuits on one hand and the external connection portion on the other to couple reception signals output from the processing circuits or distribute transmission signals input from the external connection portion to the processing circuits.

According to a second aspect of the present invention, a vehicle antenna apparatus capable of corresponding to a plurality of radio communication systems comprises: a plurality of receiving antennas which receive radio waves transmitted from an external unit and output reception signals; a plurality of receiving frequency converters which frequency-convert reception signals sent from the receiving antennas; a coupler which couples output signals sent from the receiving frequency converters and outputs one output signal; and at least one external connection portion connected with an external unit to transfer at least one output signal sent from the coupler to the external unit.

According to a third aspect of the present invention, a vehicle antenna apparatus capable of corresponding to a plurality of radio communication systems comprises: a plurality of receiving antennas provided correspondingly to the radio communication systems to receive radio waves transmitted from an external unit and output reception signals; a plurality of receiving frequency converters which frequency-convert reception signals sent from the antennas; a coupler which couples output signals sent from the receiving frequency converters and outputs one output signal; at least one external connection portion connected with an external unit to transfer at least one output signal sent from the coupler to the external unit; at least one transmitting frequency converter which frequency-converts transmission signals input to the external connection portion; and at least one transmitting antenna which is set correspondingly to at least one radio communication system to receive an output signal sent from the transmitting frequency converter and radiate radio waves.

An embodiment of the present invention has a very high utility value because the embodiment can flexibly correspond to various radio communication services to be further diversified in future and the number of restrictions for the embodiment to be mounted on a vehicle is small.

Moreover, by uniting a plurality of antennas corresponding to a plurality of radio communication systems into one body, it is possible to reduce the cost of an antenna apparatus and moreover reduce the cost for setting the antenna apparatus to a vehicle.

Furthermore, because characteristics of a single antenna such as gain and interference-wave suppression are improved, advantages are obtained that the communication quality is improved, the number of interferences is reduced, and frequency resources are effectively used.

### BRIEF DESCRIPTION OF THE SEVERAL VIEWS OF THE DRAWING

FIG. 1 is a block diagram showing a configuration of a vehicle antenna apparatus according to a first embodiment of the present invention;

FIG. 2 is an outside view of the vehicle antenna apparatus according to the first embodiment;

FIG. 3 is a top view showing a configuration of an antenna portion according to the first embodiment;

FIG. 4 is a sectional view of the vehicle antenna apparatus according to the first embodiment;

FIG. 5 is an illustration showing a setting state of the vehicle antenna apparatus according to the first embodiment;

FIG. 6 is a block diagram showing a configuration of a vehicle antenna apparatus according to a second embodiment of the present invention;

FIG. 7 is a block diagram showing a configuration of a vehicle antenna apparatus according to a third embodiment of the present invention;

FIG. 8 is a block diagram showing a configuration of a vehicle antenna apparatus according to a fourth embodiment of the present invention;

FIG. 9 is a block diagram showing a configuration of a vehicle antenna apparatus according to a fifth embodiment of the present invention;

FIG. 10 is a block diagram showing a configuration of a vehicle antenna apparatus according to a sixth embodiment of the present invention;

FIG. 11 is a block diagram showing a configuration of a vehicle antenna apparatus according to a seventh embodiment of the present invention;

FIG. 12 is a block diagram showing a configuration of a vehicle antenna apparatus according to an eighth embodiment of the present invention;

FIG. 13 is a top view showing a configuration of an antenna portion according to the eighth embodiment;

FIG. 14 is a block diagram showing a configuration of a beam-forming network according to the eighth embodiment;

FIG. 15 is a block diagram showing another configuration of the beam-forming network according to the eighth embodiment;

FIG. 16 is an illustration showing a beam pattern by the vehicle antenna apparatus according to the eighth embodiment;

FIG. 17 is an illustration showing another beam pattern by the vehicle antenna apparatus according to the eighth embodiment;

FIG. 18 is an illustration for explaining an operation procedure in the eighth embodiment;

FIG. 19 is a block diagram showing a configuration of a vehicle antenna apparatus according to a ninth embodiment of the present invention; and

FIG. 20 is a block diagram showing a configuration of an essential portion of a vehicle antenna apparatus according to a tenth embodiment of the present invention.

### DETAILED DESCRIPTION OF THE INVENTION

Then, embodiments of the present invention are described below by referring to the accompanying drawings.

(First Embodiment)

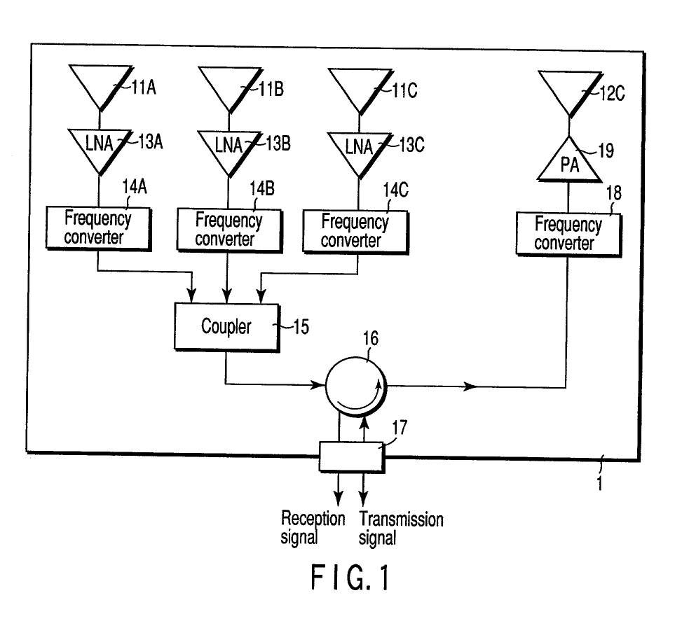

FIG. 1 is a block diagram showing a schematic configuration of a vehicle antenna apparatus according to a first embodiment of the present invention. This embodiment can correspond to three radio communication systems A, B, and C different from each other in frequency, modulation method, access method, and the like. A vehicle antenna apparatus is described below which is constituted by uniting a receiving antenna apparatus corresponding to the radio communication system A, a receiving antenna apparatus corresponding to the radio communication system B, and a transmitting and receiving antenna apparatus corresponding to the radio communication system C. In the case of mobile communication, the radio communication system A uses an 800-MHz band, the radio communication system B uses a 1.5-GHz band, and the radio communication system C uses a 2-GHz band.

That is, the vehicle antenna apparatus 1 of this embodiment is provided with receiving antennas 11A, 11B, and 11C for the radio communication systems A, B, and C and a transmitting antenna 12C for the radio communication system C.

The receiving antennas 11A, 11B, and 11C receive radio waves transmitted from base stations (not shown) corresponding to the radio communication systems A, B, and C and output electrical signals, that is, reception signals. The reception signals sent from the receiving antennas 11A, 11B, and 11C are amplified by low-noise amplifiers (LNA) 13A, 13B, and 13C which are preamplifiers and then, frequency-converted from a RF (radio frequency) band to an IF (intermediate frequency) band by receiving frequency converters (down-converters) 14A, 14B, and 14C.

Thus, reception signals corresponding to the radio communication systems A, B, and C are amplified and frequency-converted to an IF band and then, guided by a coupler 15 and united (synthesized) into one signal. For example, if a plane line such as a microstrip line is used as coupler 15, the matching characteristic can be improved by changing the shape or line width of a connecting portion. An output signal sent from the coupler 15 is guided to an input/output terminal 17 serving as an external connection terminal through a circulator 16 serving as a separation element for separating a transmission signal from a reception signal. The input/output terminal 17 connects with a transceiver serving as an external unit (not shown) through a cable (not shown) and a reception signal output from the circulator 16 through the input/output terminal 17 is transferred to the receiving section of the transceiver.

In this case, the frequency converters 14A, 14B, and 14C frequency-convert reception signals corresponding to the radio communication systems A, B, and C to frequencies in IF bands different from each other. Thus, when making different frequency bands of reception signals different from each other every radio communication system, it is possible to easily obtain a reception signal corresponding to a desired radio communication system by using, for example, a filter for the receiving section of a transceiver.

Moreover, a transmission signal transmitted from a transmitting section of a transceiver (not shown) is input to the input/output terminal 17 through a cable (not shown) and separated from a reception signal by the circulator 16. The circulator 16 can separately transmit a transmission signal and a reception signal through paths different from each other in accordance with the transfer directivity of the circulator 16. When setting a transmission signal and a reception signal to different frequency bands, it is also allowed to use a duplexer (diplexer) instead of the circulator 16 as a separation element for separating a transmission signal from a receiving signal.

A transmission signal obtained by being separated from a reception signal by the circulator 16 is frequency-converted to a predetermined RF band by a transmitting frequency converter (up-converter) 18 and amplified by a power amplifier (PA) 19 and then, guided to the transmitting antenna 12C for the radio communication system C. Thereby, the transmission signal is radiated as radio waves by the transmitting antenna 12C and transmitted to a base station (not shown) corresponding to the radio communication system C.

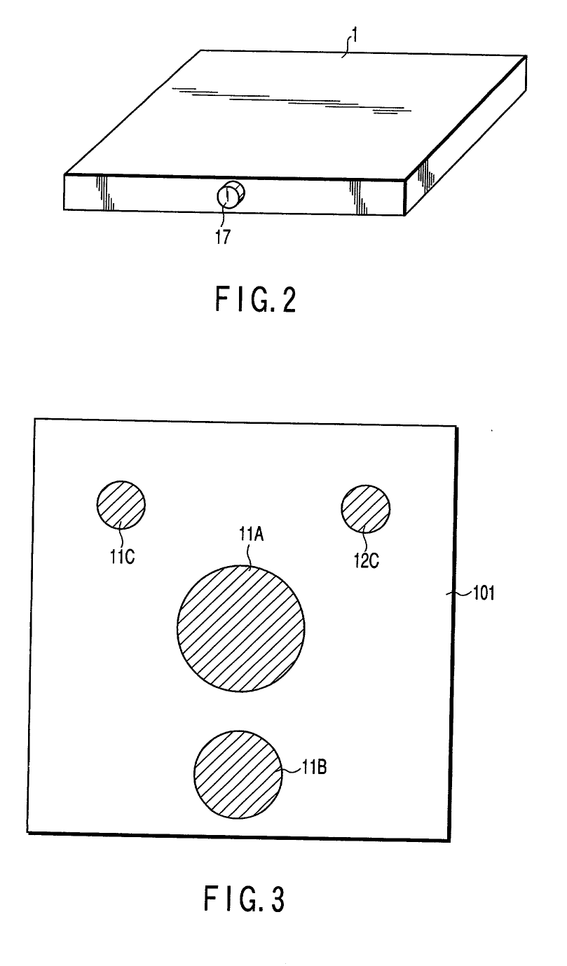

The antenna apparatus 1 whose appearance is shown in FIG. 2 is constituted by physically integrating the above-described components, in which signals are transferred to and from a transceiver serving as an external unit through the only one input/output terminal 17 and a cable for connecting the terminal 17 with the transceiver. A power source for operating an amplifier and a frequency converter is omitted in FIG. 1. It is allowed to use a battery built in the antenna apparatus 1 as the power source of the antenna apparatus 1 or use a configuration to which power is supplied from an external unit. Moreover, a cable used for communication may be used as a power-source cable. Furthermore, though only basic components are shown in FIG. 1, it is allowed to properly insert other device such as a filter for cutting off a signal having an unnecessary frequency component supplied from an external unit.

FIG. 3 shows a top view of an antenna portion formed at the top of the inside of the antenna apparatus 1 according to this embodiment. The antennas 11A, 11B, 11C, and 12C are formed on a dielectric substrate 101 through vapor deposition or sputtering or etching. This configuration is a planar antenna referred to as a microstrip antenna, which is effective as a vehicle antenna apparatus whose setting space is limited because the antenna portion can be reduced in thickness and weight.

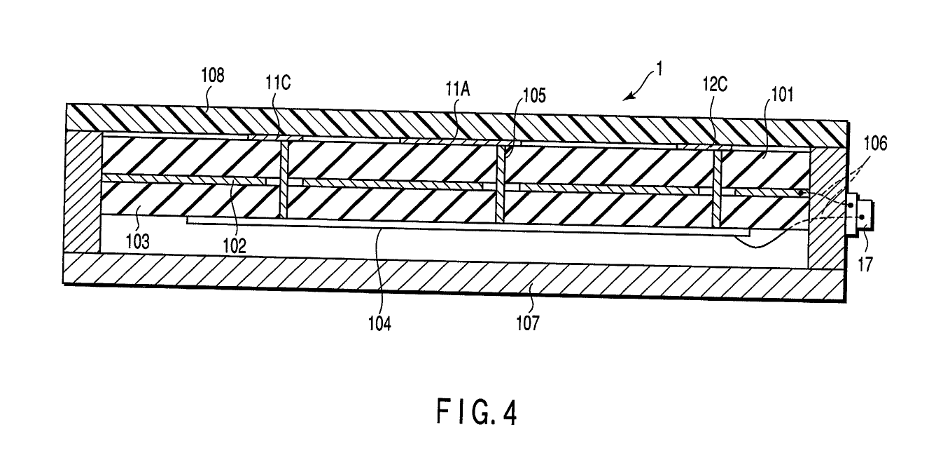

FIG. 4 shows a sectional view of the antenna apparatus 1. A ground-conductor film 102 is formed on the back of the first dielectric substrate 101 on which the antennas 11A, 11B, 11C and 12C are formed and a second dielectric substrate 103 is arranged to the lower portion of the ground-conductor film 102. An RF circuit 104 other than the antennas 11A, 11B, 11C, and 12C is formed on the upper face of the second dielectric substrate 103 opposite to the ground-conductor film 102.

The RF circuit 104 includes analog devices such as the low-noise amplifiers 13A, 13B, and 13C, receiving frequency converters 14A, 14B, and 14C, synthesizer 15, circulator 16, transmitting frequency converter 18, and power amplifier 19 shown in FIG. 1, and moreover includes transmission lines such as a microstrip line and a semi-rigid cable. The RF circuit 104 is constituted by a planar-circuit system or an MMIC (Monolithic Microwave Integrated Circuit).

The antennas 11A, 11B, 11C, and 12C are connected with the RF circuit 104 by a through-hole 105 vertically passing between the dielectric substrates 101 and 103. The input/output terminal 17 described for FIG. 1 is constituted by the so-called coaxial connector having an external conductor and a central conductor in the case of FIG. 4, and the connection of the external conductor of the input/output terminal 17 with the ground-conductor film 102 and the connection of the central conductor of the input/output terminal 17 with the RF circuit 104 are performed by a wire 106 in the case of FIG. 4.

The first dielectric substrate 101 on which the antennas 11A, 11B, 11C, and 12C are formed and the dielectric substrate 102 on which the RF circuit 104 is formed are housed in a housing 107 and moreover, a cover 108 for protecting the antennas 11A, 11B, 11C, and 12C is put on the dielectric substrate 101. By forming the housing 107 by a metal, not only the housing 107 becomes strong but also it is possible to prevent devices in the antenna 1 from being influenced by noises (unnecessary radio waves) emitted from the inside of a vehicle on which the antenna apparatus 1 is mounted or malfunctions from occurring.

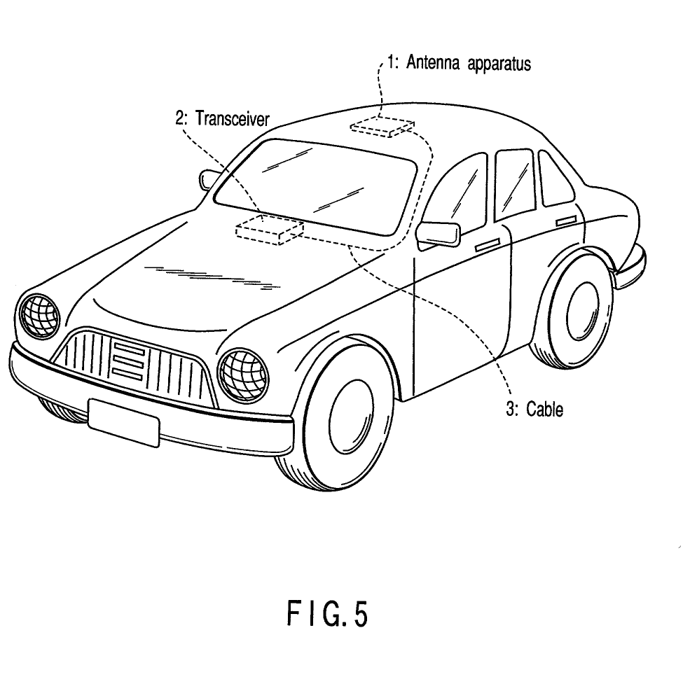

FIG. 5 shows an example of mounting the antenna apparatus 1 according to this embodiment on an automobile. The antenna apparatus 1 is set on the upper portion of the automobile and connected with a transceiver 2 provided at the vehicle interior (in this example, in the vicinity of driver's seat) through a cable 3. It is preferable that the antenna apparatus 1 is set so as to be opened upward by considering the direction of a communication counterpart. However, it is also allowed to decide the setting place of the system 1 in accordance with the design or structure of a vehicle. Therefore, the setting place is not restricted to the example shown in FIG. 5.

The following advantages can be expected for the vehicle antenna apparatus 1 according to this embodiment.

(1) By integrating an antenna and an RF circuit both of that correspond to a plurality of radio communication systems, it is possible to very compactly constitute the whole of them compared to the case of separately constituting them and decrease them in size, thickness, and cost. Therefore, it is possible to decrease an area on a vehicle in which the antenna apparatus 1 is arranged and this is preferable in designing and manufacturing the whole of the vehicle. Moreover, this is effective from the viewpoint of cost.

(2) It is possible to completely independently arrange the antenna apparatus 1 and the transceiver 2. When a vehicle on which the antenna apparatus 1 is mounted is an automobile, designing and manufacturing an engine and its control system have priority and moreover, there are restrictions for design. Because the antenna apparatus 1 of this embodiment can be arranged to one place of a car body, restrictions on a setting place are extremely decreased and therefore, it can be said that the flexibility for designing and manufacturing an automobile is high.

For example, it is possible to optionally select setting the antenna apparatus 1 to the upper portion of a certain type of automobile or setting the system 1 in the hood of other type of automobile. In short, the vehicle antenna apparatus of this embodiment can be flexibly set to any type of automobile.

(3) By transmitting transmission and reception signals of a plurality of radio communication systems through one cable 3, it is possible to make a transmission path including the cable 3 compact. Particularly, as described for the above embodiment, by frequency-converting a reception signal or a transmission signal in the antenna apparatus 1 and transmitting the signal in a frequency band (IF band) lower than the frequency band (RF band) of radio waves, it is possible to decrease the loss in a transmission path and thereby keep a preferable communication quality.

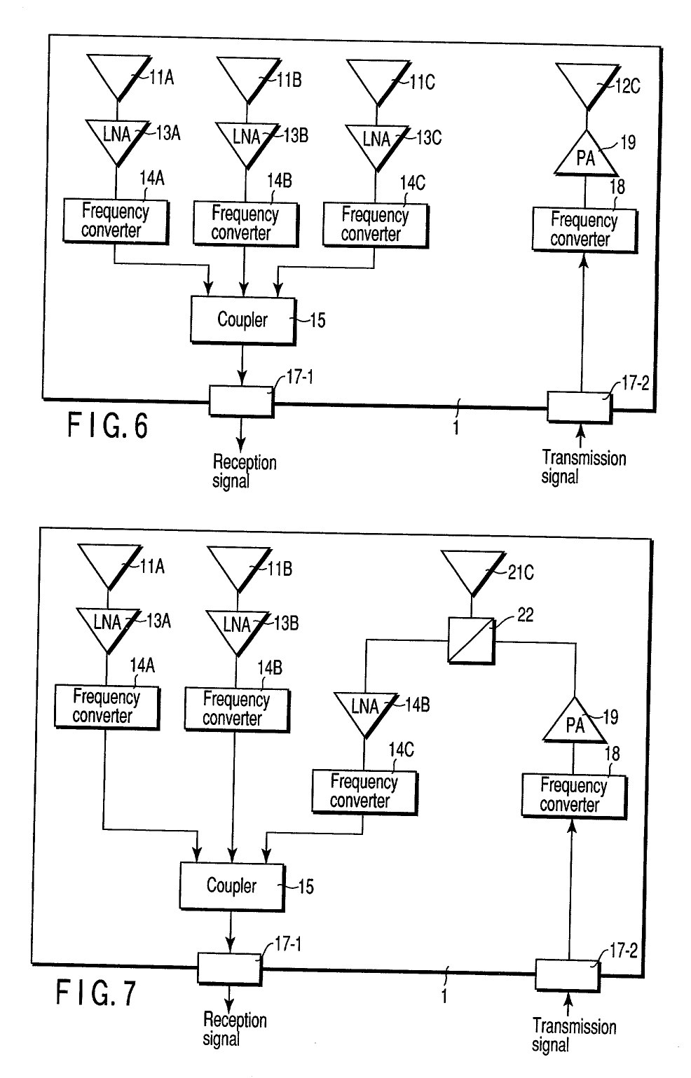

Then, several embodiments obtained by modifying the first embodiment described for FIGS. 1 to 5 are described below by referring to FIGS. 6 to 11.

(Second Embodiment)

The embodiment described for FIGS. 1 to 5 uses one input/output terminal 17 in order to transfer a reception signal and a transmission signal between the antenna apparatus 1 and the transceiver 2. However, an output terminal 17-1 may be separated from an input terminal 17-2 as shown in FIG. 6. In this case, however, two cables are required to connect the antenna apparatus 1 with the transceiver 2.

Thus, by separating a transmission signal from a reception signal, it is possible to raise the isolation between transmission and reception and prevent a communication quality from deteriorating due to the interference between transmission and reception signals. In other words, a device such as a filter for achieving a high isolation to secure a high communication quality is unnecessary and it is possible to easily realize the whole apparatus at a low cost.

(Third Embodiment)

Though the first and second embodiments respectively use a different antenna for each radio communication system and for every transmission/ reception, it is also allowed to use a part of an antenna for transmission and reception in common as shown in FIG. 7. In general, the same communication systems frequently use the same frequency for transmission and reception or frequencies comparatively close to each other. In this case, it is possible to use an antenna for transmission and reception in common.

The third embodiment shown in FIG. 7 uses a transceiving antenna 21C for a radio communication system C. A signal received by the antenna 21C is input to a low-noise amplifier (LNA) 14B by a branching filter 22. A transmission signal amplified by a power amplifier (PA) 19 is input to the transceiving antenna 21C through the branching filter 22 serving as a separation element for separating a transmission signal from a reception signal and radiated from the antenna 21C as radio waves. The branching filter 22 is used when a transmission frequency is different from a reception frequency. When the transmission frequency is the same as the reception frequency, it is also possible to switch the antennas 21C for transmission and reception by using a switch. Moreover, it is allowed to use a circulator as a separation element instead of the branching filter 22 similarly to the case of FIG. 1.

Thus, by using a part of an antenna in common, it is possible to decrease the area for setting the antenna apparatus 1 and thereby, further compactly constitute the whole vehicle antenna apparatus. Therefore, it is possible to decrease the area of a place for setting the antenna apparatus 1, the versatility of a place where the system 1 is mounted on a vehicle increases and advantages for design and manufacture are further increased.

(Fourth Embodiment)

In the case of the first to third embodiments, signals are transferred between the vehicle antenna apparatus 1 and an external transceiver in an IF-band analog signal area. However, it is also possible to transfer signals in a digital- or optical-signal area.

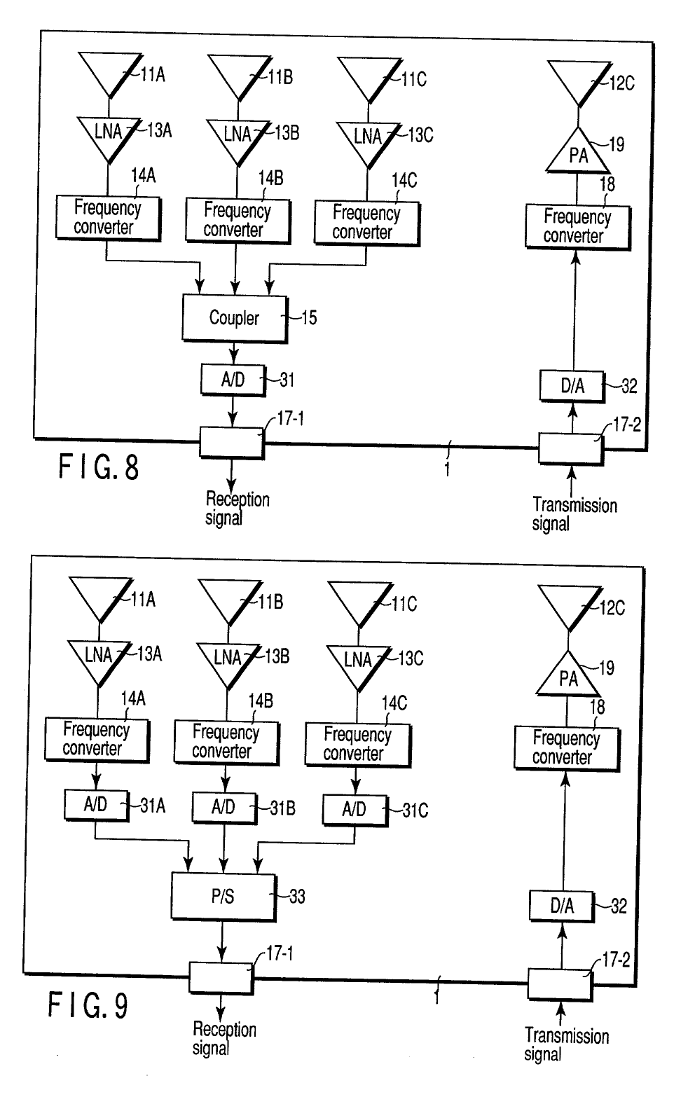

In the case of the fourth embodiment shown in FIG. 8, a configuration for transferring signals between the antenna apparatus 1 and the external transceiver is illustrated. Reception signals sent from antennas 11A, 11B, and 11C are synthesized by a synthesizer 15 after passing through low-noise amplifiers 13A, 13B, and 13C and receiving frequency converters 14A, 14B, and 14C and then converted to digital signals by an A/D converter (analog/digital converter) 31, and transferred to the receiving section of a transceiver (not shown) through an output terminal 17-1.

However, a digital signal serving as a transmission signal in an IF band or base band sent from the transmitting section of a transceiver (not shown) is input to the antenna apparatus 1 through an input terminal 17-2, converted to an analog signal by a D/A converter (digital/analog converter) 32, then input to the antenna 12C through a transmitting frequency converter 18 and a power amplifier 19.

This embodiment is strong for deterioration of the signal quality due to noises in a signal transfer path because digital signals are transferred between the antenna apparatus 1 and the transceiver. Moreover, an advantage is obtained that by applying the processing such as error-correction encoding to a digital signal, it is easy to maintain a high signal quality.

(Fifth Embodiment)

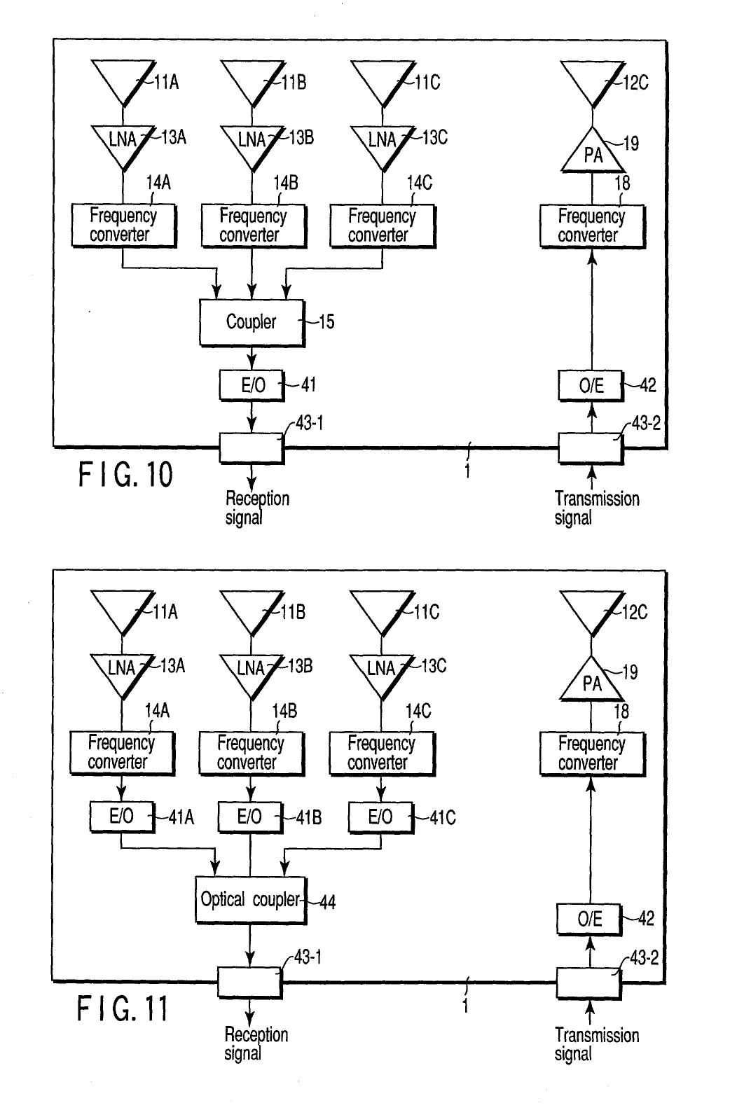

FIG. 9 shows a vehicle antenna apparatus 1 according to a fifth embodiment obtained by further modifying the configuration in FIG. 8. Reception signals sent from antennas 11A, 11B, and 11C are amplified by low-noise amplifiers 13A, 13B and 13C, frequency-converted by receiving frequency converters 14A, 14B, and 14C, and then converted to digital signals by A/D converters 31A, 31B, and 31C before the signals are synthesized into one signal.

The reception signals converted to digital signals output from A/D converters 31A, 31B, and 31C are input to a parallel/serial (P/S) converter 33. The P/S converter 33 rearranges the simultaneously-input digital signals to series signals and outputs them to an output terminal 17-1. That is, in the case of this example, the P/S converter 33 serves as a coupler for coupling a plurality of reception signals into one signal.

In the case of the first to fourth embodiments, reception signals for each radio communication system have frequency components different from each other and therefore, the receiving section of the transceiver must fetch frequency components by separating them from each other. On the contrary, in the case of the fifth embodiment shown in FIG. 9, reception signals having frequency components different from each other for each radio communication system are transferred to the receiving section of a transceiver as time-series digital signals. Therefore, it is not always necessary that the receiving frequency converters 14A, 14B and 14C frequency-convert receptions signals into an IF band but it is allowed to convert them into the BB (base band) whose post processing can be easily made. Thereby, an advantage is obtained that the configuration of the receiving section can be simplified. That is, when the reception signals are kept in the BB, they are digital signals. Therefore, an advantage is obtained that a receiver can be constructed by software.

Moreover, in this case, because the signals are converted into the base band that is a low frequency, it is possible to operate the A/D converters 31A, 31B, and 31C at a comparatively-low clock frequency. Therefore, advantages are obtained that it is possible to use an inexpensive device for the A/D converters 31A, 31B, and 31C and reduce the cost of the whole system. (Sixth embodiment) FIG. 10 shows a configuration of a vehicle antenna apparatus 1 according to a sixth embodiment of the present invention in which communication with an external transceiver is performed by optical signals.

Reception signals sent from antennas 11A, 11B, and 11C are synthesized by a synthesizer 15 after passing through low-noise amplifiers 13A, 13B, and 13C and receiving frequency converters 14A, 14B, and 14C and then, converted into optical signals by an E/O converter (electrooptical converter) 41, and transferred to the receiving section of a transceiver (not shown) from an optical output terminal 43-1 serving as an external connection terminal through an optical fiber (not shown).

A transmission signal serving as an optical signal sent from the transmitting section of a transceiver (not shown) through an optical fiber (not shown) is input to the antenna apparatus 1 through an optical input terminal 43-2 serving as an external connection terminal, converted into an electrical signal in an IF band or base band by an O/E converter (electrooptical converter) 42, and then input to an antenna 12C through a transmitting frequency converter 18 and a power amplifier 19.

According to this embodiment, because signals are transferred between the vehicle antenna apparatus 1 and the transceiver through an optical fiber, an advantage is obtained that the signals do not easily receive interferences by radio waves. Particularly, most units mounted on an automobile generate electromagnetic-wave noises due to an included computer. However, this embodiment can suppress the number of interferences due to electromagnetic-wave noises to communication.

(Seventh Embodiment)

FIG. 11 shows a configuration of a vehicle antenna apparatus 1 according to a seventh embodiment of the present invention obtained by modifying the configuration in FIG. 10.

Reception signals sent from antennas 11A, 11B, and 11C are converted into frequencies different from each other for every radio communication system by receiving frequency converters 14A, 14B, and 14C through low-noise amplifiers 13A, 13B, and 13C and then, converted into optical signals by E/O converters 41A, 41B, and 41C. Optical signals sent from the E/O converters 41A, 41B, and 41C are synthesized into one optical signal by an optical coupler 44 and then transferred from an optical output terminal 43-1 to the receiving section of a not-illustrated transceiver through an optical fiber (not shown). Even the above configuration makes it possible to obtain the same advantage as that of the sixth embodiment. In this case, the optical signal converted by the E/O converter may be of different optical frequency for every system.

(Eighth Embodiment)

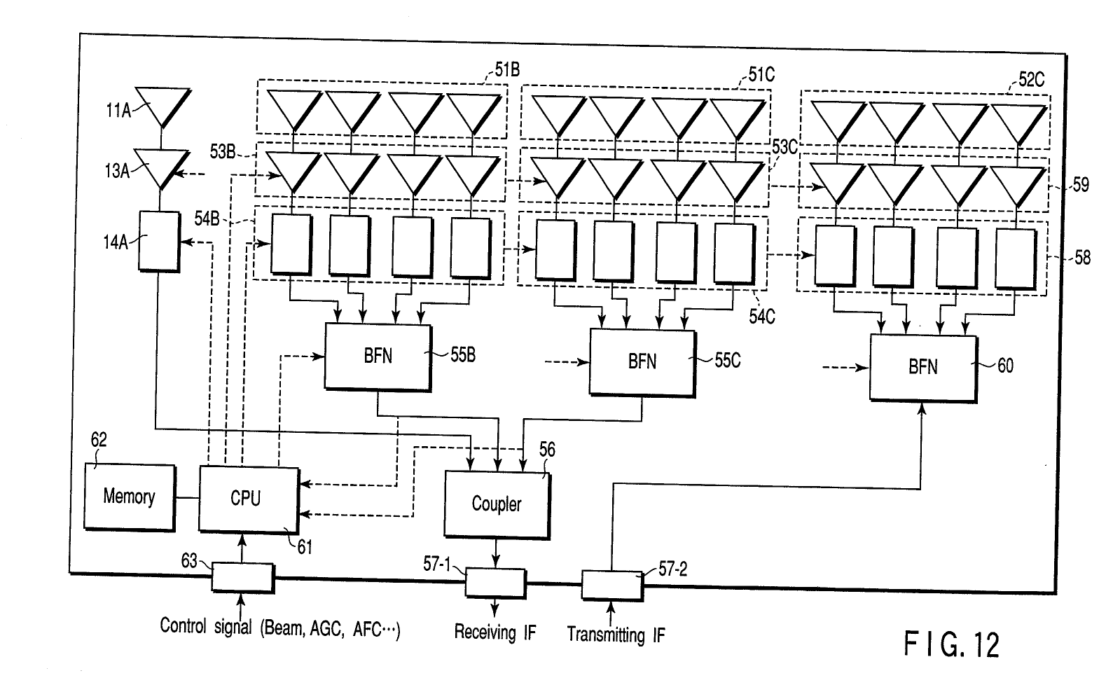

FIG. 12 is a block diagram showing a configuration of a vehicle antenna apparatus according to an eighth embodiment of the present invention. This embodiment relates to a vehicle antenna apparatus 1 capable of performing only reception from radio communication systems A and B and both transmission and reception to and from a radio communication system C similarly to the case of the first to seventh embodiments.

In this case, though a receiving antenna for the radio communication system A uses a single antenna 11A similarly to the case of the first to seventh embodiments, receiving antennas for the radio communication systems B and C use array antennas 51B and 51C. Moreover, the eighth embodiment is different from the first to seventh embodiments in that a transmitting antenna for the radio communication system C uses an array antenna 52C. Though the array antennas 51B, 51C, and 52C respectively use a four-element array antenna, the number of elements is optional and it is allowed that each array antenna has a different number of elements.

The receiving antenna 11A corresponding to the radio communication system A receives radio waves transmitted from a base station (not shown) corresponding to the radio communication system A and a reception signal output from the receiving antenna 11A is amplified by a low-noise amplifier (LNA) 13A and then, frequency-converted from a RF band to an IF band by a receiving frequency converter 14A.

The receiving array antenna 51B corresponding to the radio communication system B receives radio waves transmitted from a base station (not shown) corresponding to the radio communication system B. Four reception signals output from the receiving antenna 51B are amplified by a group of four low-noise amplifiers 53B and moreover frequency-converted from a RF band to an IF band by a group of four receiving frequency converters 54B, and then input to a beam-forming network 55B.

The receiving array antenna 51C corresponding to the radio communication system C also receives radio waves transmitted from a base station (not shown) corresponding to the radio communication system C. Four reception signals output from the receiving array antenna 51C are amplified by a group of four low-noise amplifiers 53C, frequency-converted from an RF band into an IF band by a group of four receiving frequency converters 54C, and then input to a beam-forming network 55C.

In the beam-forming networks 55B and 55C, predetermined complex weighting (weighting of exciting amplitude and exciting phase) is applied to four input reception signals, that is, a predetermined exciting condition is set to the four signals and then the four signals are synthesized into one signal. Reception signals output from the receiving frequency converter 14A and beam-forming networks 55B and 55C and frequency-converted into an IF band are united into one signal by a coupler 56, output from an output terminal 57-1 serving as an external connection terminal to the outside of an antenna apparatus, and transferred to the receiving section of a transceiver (not shown) serving as an external unit through a cable (not shown) In the frequency converter 14A and frequency-converter groups 54B and 54C, reception signals corresponding to the radio communication systems A, B, and C are frequency-converted into IF-band frequencies different from each other. Thereby, the eighth embodiment is the same as the first embodiment in that it is possible to easily fetch a reception signal corresponding to a desired radio communication system by using, for example, a filter for the receiving section.

Moreover, a transmission signal transmitted from the transmitting section of a not-illustrated transceiver is input from an input terminal 57-2 serving as an external connection terminal to a beam-forming network 60 through a not-illustrated cable. In the beam-forming network 60, predetermined exciting conditions (exciting amplitude and exciting phase) are set correspondingly to antenna elements of the transmitting array antenna 52C corresponding to the radio communication system C and four output signals are output. Four output signals sent from the beam-forming network 60 are guided to the transmitting array antenna 52C through a transmitting frequency converter group 58 and a power-amplifier group 59, radiated from the antenna 52C as radio waves, and transmitted to a not-illustrated base station corresponding to the radio communication system C.

Thus, in the case of this embodiment, it is possible to form a desired beam pattern (directivity pattern) for every receiving systems of the radio communication systems B and C and for every transmitting system of the radio communication system C by using the array antennas 51B, 51C, and 52C and the beam-forming networks 55B, 55C, and 60 and setting predetermined exciting conditions to the beam-forming networks 55B, 55C, and 60.

The control (transfer of exciting conditions) for setting exciting conditions to the beam-forming networks 55B, 55C, and 60 is performed by a CPU (processing circuit) 61. The CPU 61 is controlled in accordance with a control signal input from a not-illustrated external unit (e.g. transceiver) to a control-signal input terminal 63. The CPU 61 connects with a memory 62 in which the information necessary for beam-pattern control, specifically various exciting conditions (exciting amplitude and exciting phase), that is, the information for complex weighting coefficients are previously stored. For example, when the CPU 61 is designated so as to turn an antenna beam to a certain-angle direction in accordance with a control signal sent from an external unit, the CPU 61 detects a complex weighting coefficient for each antenna element necessary for turning the antenna beam to the direction out of the memory 62 and transfers and sets the coefficient to the beam-forming networks 55B, 55C, and 60.

The CPU 61 can perform controls other than the control for the beam-forming networks 55B, 55C and 60 according to necessity as shown by broken lines in FIG. 12. That is, the CPU 61 can also control gains (amplification rates) for the low-noise amplifier 13A and low-noise amplifier groups 53B and 53C. For example, the CPU 61 can save the dynamic range of a reception signal by performing controls so as to decrease a gain for a reception signal having a strong level and increase a gain for a reception signal having a weak level.

Moreover, the CPU 61 makes it possible to obtain an advantage of reducing the number of interferences to other user of a base station by decreasing transmission power when a transmission counterpart is near and increasing the transmission power when the counterpart is far in accordance with the transmission control to a power-amplifier group 59.

Furthermore, the CPU 61 can select a channel by controlling the frequency converter 14A and frequency-converter groups 54B and 54C.

Thus, by using the CPU 61 for performing the control for setting exciting conditions to the beam-forming networks 55B, 55C, and 60, it is possible to control other various devices in the antenna apparatus 1 and thereby, decrease the number of external connection terminals and the number of cables for connection with external units in the antenna apparatus 1.

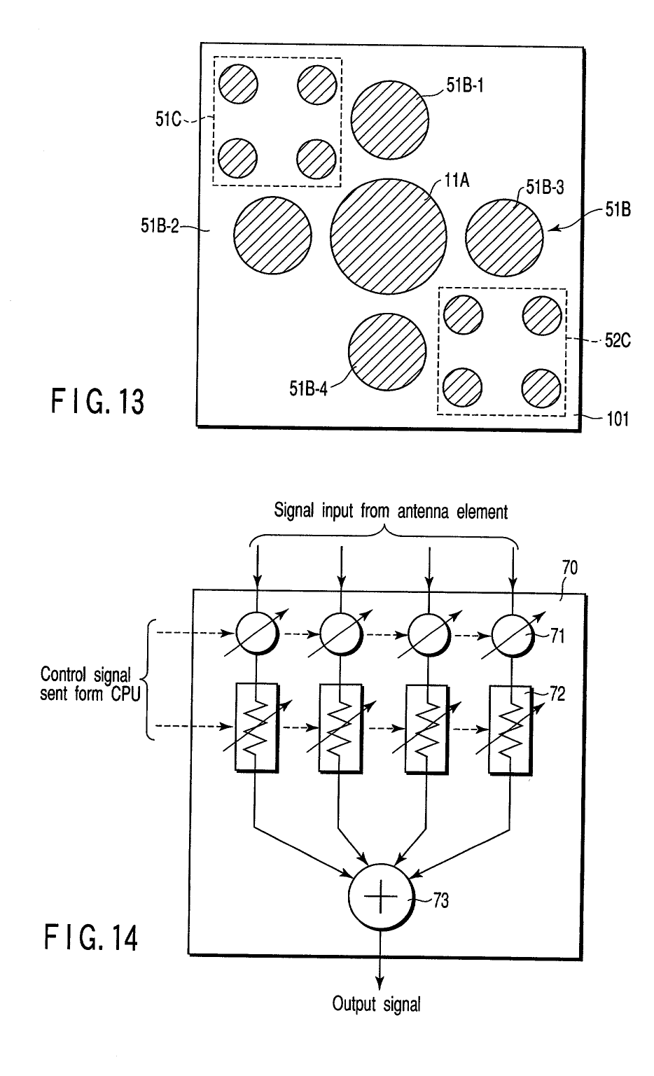

FIG. 13 shows a top view of an antenna portion formed on the top of the inside of the antenna apparatus 1 of this embodiment. An antenna 11A, array antenna 51B (51B-1 to 51B-4), array antenna 51C, and array antenna 52C are formed on a dielectric substrate 101 through vacuum deposition or sputtering or etching. This configuration is a planar antenna (microstrip antenna) basically same as the antenna portion of the first embodiment shown in FIG. 3 and the antenna portion can be decreased in thickness and weight and is effective as a vehicle antenna apparatus whose setting space is limited.

In the case of this embodiment, because the array antennas 51B (51B-1 to 51B-4), 51C, and 52C are included in the antenna portion differently from the case of FIG. 3, the number of antenna elements is increased. Therefore, to decrease the antenna setting area, it is also possible to form antenna elements to be operated at different frequencies by vertically superimposing them at the both sides of a dielectric substrate.

Then, the beam-forming networks 55B, 55C, and 60 of the receiving system of this embodiment are described below.

A beam-forming network 70 in FIG. 14 shows a configuration of receiving-system beam-forming networks 55B and 55C. An input signal sent from each antenna element constituting an array antenna is input to a phase shifter 71 and a reception-signal exciting phase serving as one of exciting conditions is set to a predetermined value in accordance with a control signal sent from the CPU 61 in FIG. 12. An output signal of the phase shifter 71 is input to a variable attenuator 72 in which a reception-signal exciting amplitude serving as other one of exciting conditions is set in accordance with a control signal sent from the CPU 61. Thus, the reception signals to which the exciting phase and exciting amplitude are set are synthesized by a synthesizer 73 and output as an output signal of the beam-forming network 70.

Thus, the reception signals to which suitable exciting condition are set and which are synthesized can resultantly form a desired beam pattern, turn a beam to a predetermined direction, change cover areas, and produce a zero point (null) on a pattern in order to suppress the number of interference waves. It is also allowed to use a variable gain amplifier instead of the variable attenuator 72. Moreover, it is allowed to properly add an amplifier or filter to the configuration in FIG. 14. It is also possible to form the transmitting-system beam-forming network 60 by a configuration basically same as the configuration in FIG. 14 because the signal transfer direction is only reversed.

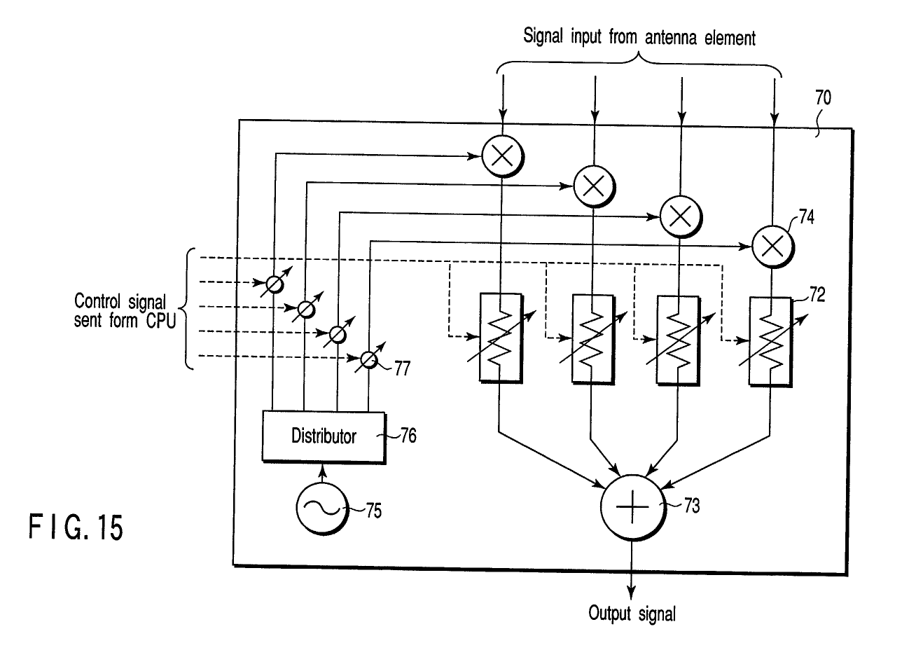

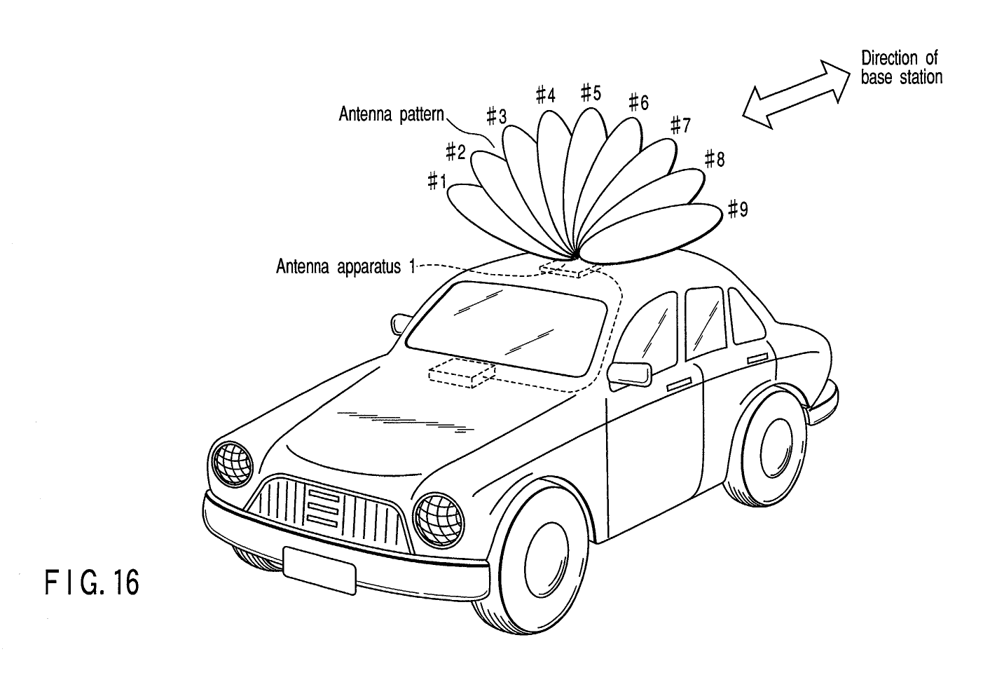

The beam-forming network 70 in FIG. 15 shows other configuration of the receiving-system beam-forming networks 55B and 55C. This configuration simultaneously performs exciting-phase setting and frequency conversion of a reception signal.

That is, local signals (carrier frequencies) generated by a local-signal generator 75 are distributed to each antenna element by a distributor 76 and then, phase-shifted by a phase shifter 77 for controlling a shift value in accordance with a control signal sent form the CPU 61 in FIG. 12 and thereby, a predetermined exciting phase is set to the local signals.

The local signals to which the exciting phase is thus set are multiplied to reception signals of antenna elements by a mixer (multiplier) 74 and frequency components are fetched from the local signals and reception signals by a not-illustrated filter, then, an exciting amplitude is set to the local signals by the variable attenuator 72 whose attenuation rate is controlled in accordance with a control signal sent from the CPU 61, then synthesized by the synthesizer 73, and output as output signals of the beam-forming network 70. It is also possible to use the same configuration for a transmitting system because a signal-transfer direction is only reversed.

According to the configuration in FIG. 15, it is possible to simultaneously perform frequency conversion from a RF band to an IF band in a beam-forming network. Therefore, it is possible to realize the simple configuration shown in FIG. 12 from which frequency-converter groups 54B and 54C are removed. Moreover, the phase shifter 77 sets an exciting phase to a signal containing only a carrier frequency component and has an advantage that the shifter 77 can be simply and inexpensively realized compared to the phase shifter 71 having the configuration in FIG. 14 for setting an exciting phase to a signal having a band.

FIG. 16 shows a setting state and operations of the vehicle antenna apparatus 1 of this embodiment. For example, as shown in FIG. 16, the vehicle antenna apparatus 1 is set on the roof of a vehicle to perform communication with the base station of a certain radio communication system. Antenna patterns (beams) #1 to #9 having beam directions different from each other are successively changed in accordance with the beam control by a beam-forming network and an optimum beam facing to the direction of the base station, for example, the beam #8 in FIG. 16 is selected to perform communication by using the selected beam #8. Because an automobile always moves and directions of it are changed, an optimum beam is selected each time to perform communication.

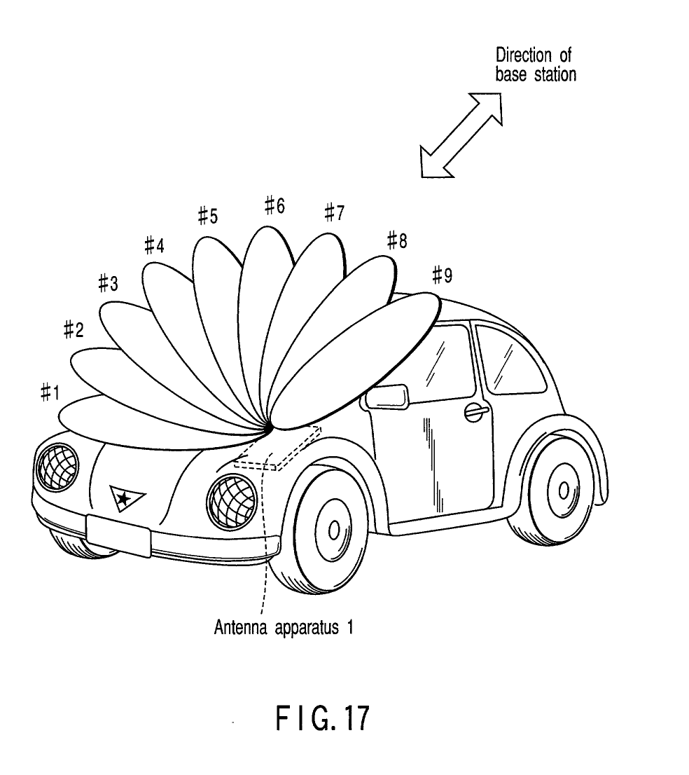

FIG. 17 shows other setting state and operations of the vehicle antenna apparatus 1 of this embodiment. In this case, the type of vehicle on which the antenna apparatus 1 is mounted is different from the type of vehicle in FIG. 16 and thereby, the setting place of the antenna apparatus 1 is changed from the roof of the vehicle to the hood of the vehicle in FIG. 17. Therefore, even if the setting place of the antenna apparatus 1 differs, it is possible to perform communication using an optimum beam by switching beams or selecting a beam. Moreover, an antenna pattern is influenced by the state of a setting place of the antenna apparatus 1 and thereby, frequently greatly changed. Even in this case, a probability that an optimum beam can be selected is raised by using a function for changing a plurality of antenna patterns to select an optimum beam.

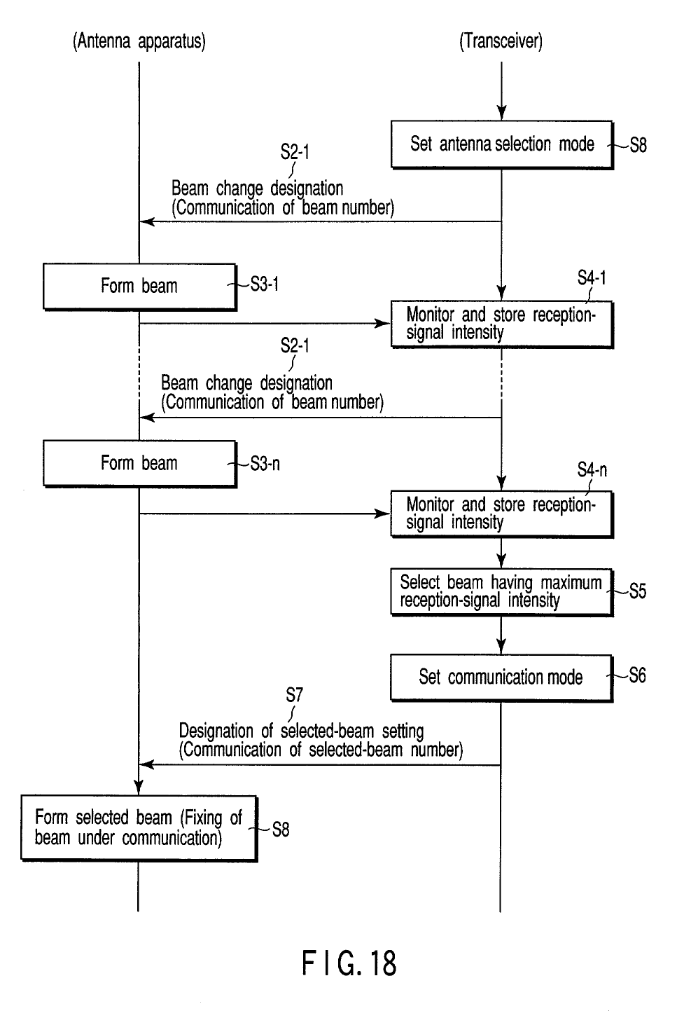

A specific control procedure for performing the above antenna-beam control is described below by using the flowchart shown in FIG. 18.

First, a procedure is described below in which a transceiver selects and sets an optimum beam coinciding with the incoming direction of radio waves. First, the transceiver connected to the antenna apparatus 1 selects an antenna selection mode (step S1). In this antenna mode, the information for beam numbers is transmitted from the transceiver to the antenna apparatus 1 as a control signal in order to designate the antenna apparatus 1 to change antennas and a beam number is communicated to the antenna apparatus 1 (step S2-1). The antenna apparatus 1 sets exciting conditions (exciting amplitude and exciting phase) to a beam-forming network (e.g. beam-forming network 55B or 55C) in accordance with the communicated beam number to form a beam (step S3-1). The transceiver monitors and stores the reception-signal intensity at the beam (step S4-1). Thereafter, beam numbers are changed to repeat n times a procedure same as that of step S2-1 to step S4-1 from step S2-n to S4-n.

Then, the transceiver selects a beam in which the reception-signal intensity is maximized (step S5) and starts the communication mode (step S6). In the communication mode, the information for the beam number selected in step S5 is transmitted from the transceiver to the antenna apparatus 1 to communicate the beam number (step S7). The antenna apparatus 1 forms a beam corresponding to the communicated beam number and fixes the beam during communication (step S8).

According to the above procedure, it is possible to easily select and fix a beam most suitable for communication and keep an optimum communication line independently of the position, direction, and gradient of a vehicle.

Also when performing the beam control of a transmitting system, the above control procedure can be used. That is, it is allowed to use an optimum beam selected by a reception signal as a beam for transmission. When frequencies are different from each other in transmission and reception, it is allowed to set an exciting weight obtained by converting the shift of the frequency characteristic. Moreover, in addition to forming of the same beam in transmission and reception, it is possible to form a wide-angle pattern for a transmitting beam in accordance with a result of beam selection by a reception signal.

The procedure shown in FIG. 18 is described by assuming that control is performed in cooperation between the antenna apparatus 1 and a transceiver. However, it is possible to close this beam control in an antenna apparatus. For example, as shown in FIG. 12, by branching some of output signals of the receiving-system beam-forming networks 55B and 55C and inputting them to the CPU 61, it is possible to autonomously monitor a reception-signal intensity or select and set an optimum beam. In this case, the antenna apparatus 1 automatically selects an optimum beam and thereby, it is possible to reduce the load for control of a transceiver and omit or reduce transfer frequencies of control signals between the antenna apparatus 1 and the transceiver.

Moreover, as described above, to set a beam pattern by a beam-forming network, it is possible to form a pattern for producing a null (zero point) in the direction of a interference radio wave so as to not only turn a beam toward the direction of a communication counterpart such as a base station but also suppress the number of interference radio waves of other user or a radio communication system. In this case, an exciting condition is decided in accordance with an algorithm for maximizing only a desired signal component included in, for example, a reception signal by the CPU 61 of the antenna apparatus 1 or the computing section of a transceiver.

The vehicle antenna apparatus 1 of this embodiment can achieve advantages same as those of the first to seventh embodiments and moreover, expect the following advantages.

(1) Because a beam can be thinned, an antenna gain is improved. Therefore, a signal-to-noise ratio (S/N ratio) is raised and communication quality is improved. Particularly, when performing wide-band multimedia communication, a large effect is obtained because a high gain is requested. From another viewpoint, it is possible to reduce transmission power by a value equivalent to the improved antenna gain and effectively use a power source.

(2) A vehicle normally uses a wide-angle antenna pattern so that transmission and reception can be made even if directions of the vehicle are changed. In this case, however, radio waves are radiated in an unnecessary direction and interferences are applied to other users. In the case of this embodiment, it is possible to radiate radio waves only in a desired direction. Therefore, advantages are obtained that it is possible to reduce the above number of interferences, allow other users in a system, improve the housing capacity of the system, and effectively use frequency resources.

(3) Because it is possible to use a function of preparing a plurality of beams and selecting an optimum beam, it is possible to keep an optimum communication line independently of the direction of a vehicle such as an automobile or the direction of a base station.

(4) When mounting an antenna on a vehicle, it is considered that the setting place of the antenna apparatus 1 differs in types of vehicles as shown in FIGS. 16 and 17. According to this embodiment, even if setting places of a vehicle antenna apparatus are changed, it is possible to perform communication using an optimum beam in accordance with beam change or beam selection and flexibly use the optimum beam independently of a type of vehicle or an antenna setting place. Therefore, it is possible to manufacture vehicle antenna apparatuses conforming to the same specification, set them to various vehicles, reduce the development and manufacturing costs, and resultantly inexpensively provide antenna apparatuses to users.

(5) It is general to consider that a plurality of radio communication systems to be used are different from each other in radio-wave transceiving direction. However, even under this state, the vehicle antenna apparatus of this embodiment can select an optimum beam for every radio-wave communication system and therefore, it has a high economic effect.

(6) It is possible to form a null pattern for suppressing the number of interference waves by controlling a beam-forming network. Therefore, it is possible to obtain a signal suppressing the number of interference waves and having a high signal-to-noise ratio (S/N ratio) in accordance with the above function. Therefore, an advantage is obtained that a preferable communication line can be realized even under an environment in which there are many users and many interfrences or an environment in which there are many interferences due to a multipath.

(Ninth Embodiment)

The eighth embodiment can be modified similarly to the case of the second to seventh embodiments and advantages same as those of the embodiments are obtained. Moreover, it is allowed to realize the following modifications.

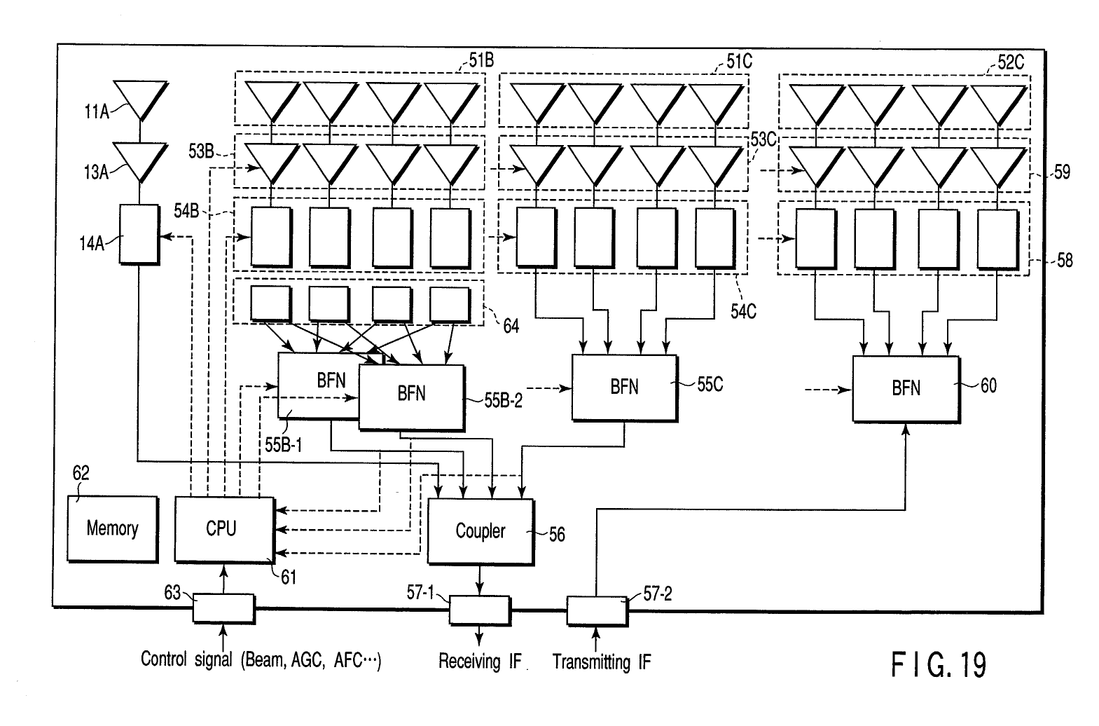

FIG. 19 shows an embodiment in which a plurality of beam-forming networks are provided for a certain radio communication system by modifying the eighth embodiment. Only differences from the configuration in FIG. 12 are described below. In the case of this embodiment, a reception signal sent from a receiving antenna 51B for a radio communication system B passes through a low-noise amplifier group 53B of and a frequency converter group 54B and then, it is divided into two signals by a distributor group 64 and the divided signals are separately input to beam-forming networks 55B-1 and 55B-2. In this case, exciting conditions are set to the two beam-forming networks 55B-1 and 55B-2 in accordance with control signals sent from a CPU 61 so as to form antenna patterns separately.

According to the configuration of this embodiment, the following advantages can be expected.

(1) By turning beam patterns toward different base stations, it is possible to smoothly perform change or handover of base stations occurring under movement.

(2) It is possible to perform pattern diversity by using reception signals having beam patterns different from each other. This is effective to obtain a preferable communication quality in a multipath or fading environment.

(3) By producing a plurality of beams, communication can be made with a plurality of communication counterparts in different directions. This is effective when a communication counterpart is a vehicle such as other car like the case of inter-car communication.

It is further allowed to modify the above eighth and ninth embodiments as described below. For example, in the case of the embodiments in FIGS. 12 and 18, the beam-forming networks 55B (55B-1, 55B-2), 55C, and 60 are arranged at the rear stage of the frequency converter groups 54B and 54C and before and after the frequency-converter group 58 so as to operate in an IF band. However, it is also allowed to use a configuration in which a beam-forming network operates in a RF band by setting the network at the rear stage of the array antennas 51B and 51C or low-noise amplifiers 53B and 53C or at the rear stage of the array antenna 52C or the power amplifier 59.

FIGS. 14 and 15 show configurations in analog-signal areas in an IF band as beam-forming networks. However, it is also allowed to use a beam-forming network in a digital signal area. In this case, an A/D converter (receiving system) or a D/A converter (transmitting system) is connected between a frequency converter and a beam-forming network and signals are transferred to and from an external transceiver in accordance with digital signals as shown in FIGS. 8 and 9. It is possible to easily realize a beam-forming network according to digital signal processing by a device such as a DSP (Digital Signal Processor) or an FPGA (Field Programmable Gate Array). In this case, an advantage is obtained that processing can be simplified by rewriting software or a memory.

(Tenth Embodiment)

Though vehicle antenna apparatuses of the first to ninth embodiments respectively have only one transmitting system, it is also possible to apply the present invention to a vehicle antenna apparatus having a plurality of transmitting systems.

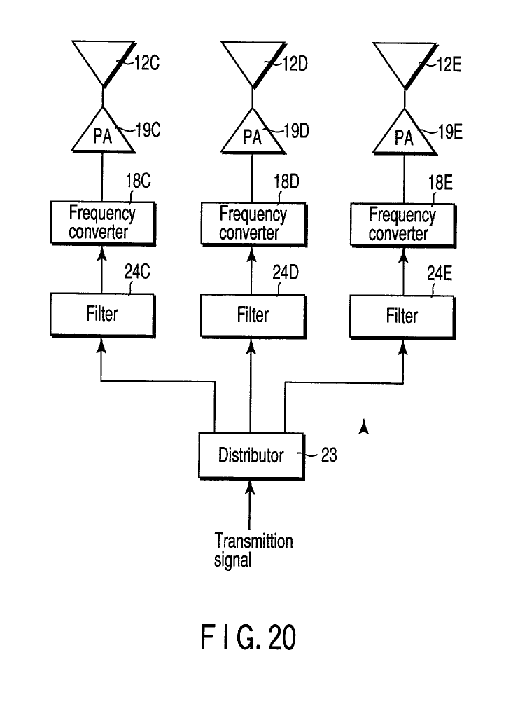

FIG. 20 is an illustration showing only transmitting systems of tenth embodiment of the present invention as the above example having a plurality of transmitting systems, in which transmitting antennas 12C, 12D, and 12E for radio communication systems C, D, and E are used.

For example, a transmission signal fetched by the circulator 16 in FIG. 1 is divided into three signals by a distributor 23 and IF-band transmission signals are fetched by filters 24C, 24D, and 24E. The divided IF-band transmission signals are converted into RF-band signals by transmitting frequency converters 18C, 18D, and 18E, amplified by power amplifiers 19C, 19D, and 19E, then supplied to transmitting antennas 12C, 12D, and 12E, and radiated as radio waves.

Similarly, it is possible to realize a vehicle antenna apparatus provided with a transmitting system including transmitting antennas (transmitting array antennas) corresponding to a plurality of communication systems by combining the configuration of this embodiment with the second to ninth embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vehicle antenna apparatus capable of corresponding to a plurality of radio communication systems, comprising:
a plurality of antennas provided correspondingly to the radio communication systems;
a plurality of processing circuits whose one ends (input ports or output ports) are connected to the antennas to apply processings including amplification and frequency conversion to signals input from the one ends of the antennas received from a corresponding antenna or signals to be transmitted to a corresponding antenna input to the other ends of the antennas;
at least one external connector configured to output reception signals to an external unit or inputs transmission signals sent from the external unit; and
a unit connected between the other ends of the processing circuits and the external connector to couple reception signals output from the processing circuits or distribute transmission signals input from the external connector to the processing circuits.

2. A vehicle antenna apparatus capable of corresponding to a plurality of radio communication systems, comprising:
a plurality of receiving antennas provided correspondingly to the radio communication systems to receive radio waves transmitted from an external unit and to output reception signals;
a plurality of receiving frequency converters configured to frequency-convert reception signals sent from the receiving antennas;
a coupler configured to couple signals output from the receiving frequency converters and to output one output signal; and
at least one external connector connected with an external unit to transfer signals output from the coupler to the external unit.

3. A vehicle antenna apparatus capable of corresponding to a plurality of radio communication systems, comprising:
a plurality of receiving antennas provided correspondingly to the radio communication systems to receive radio waves transmitted from an external unit and to output reception signals;
a plurality of receiving frequency converters configured to frequency-convert signals received from the antennas;
a coupler configured to couple signals output from the receiving frequency converters and to output one output signal;
at least one external connector connected with an external unit to transfer signals output from the coupler to the external unit;
at least one transmitting frequency converter configured to frequency-convert transmission signals input to the external connector from an external unit; and
at least one transmitting antenna provided correspondingly to at least one radio communication system to receive signals output from the transmitting frequency converter and to radiate radio waves.

4. The vehicle antenna apparatus according to claim 2, wherein the plurality of receiving frequency converters convert signals received from the plurality of receiving antennas into proximate frequencies.

5. The vehicle communication system according to claim 3, wherein the external connector includes one input/output terminal and moreover includes a separation element inserted between the input/output terminal, the output end of the coupler, and the input ends of the transmitting frequency converters to separate transmission signals from reception signals.

6. The vehicle antenna apparatus according to claim 3, wherein the external connector includes an output terminal and an input terminal, transfers signals output from the coupler to the external unit through the output terminal, and inputs signals transmitted from the external unit to the input terminal.

7. The vehicle antenna apparatus according to claim 3, further comprising a distributor configured to distribute transmission signals input to the external connector from said external unit to the transmitting frequency converters.

8. The vehicle antenna apparatus according to claim 3, wherein at least one of the receiving antennas and at least one of the transmitting antennas are used in common.

9. The vehicle antenna apparatus according to claim 2, further comprising an A/D converter configured to convert signals output from the coupler into digital signals and supplies the digital signals to the external connector.

10. The vehicle antenna apparatus according to claim 2, further comprising a plurality of A/D converters configured to convert signals output from the receiving frequency converters into digital signals and supply the digital signals to the coupler, wherein the coupler couples digital signals output from the A/D converters through parallel-serial conversion and synthesizes them into one signal.

11. The vehicle antenna apparatus according to claim 3, further comprising a D/A converter configured to convert a transmission signal input from the external connector as a digital signal into an analog signal and supplies the analog signal to the transmitting frequency converters.

12. The vehicle antenna apparatus according to claim 2, further comprising an E/O converter configured to convert a signal output from the coupler into an optical signal and supplies the optical signal to the external connector.

13. The vehicle antenna apparatus according to claim 2, further comprising a plurality of E/O converters which convert signals output from the receiving frequency converters into optical signals and supply them to the coupler, wherein the coupler couples optical signals output from the E/O converters and synthesizes them into one optical signal.

14. The vehicle antenna apparatus according to claim 3, further comprising an O/E converter which converts a transmission signal input from the external connector as an optical signal into an electrical signal and supplies the electrical signal to the transmitting frequency converters.

15. The vehicle antenna apparatus according to claim 1, wherein at least one of the antennas is an array antenna and a beam-forming network for forming an optional antenna beam through the array antenna is included.

16. The vehicle antenna apparatus according to claim 15, further comprising a CPU which controls the beam-forming network.

17. The vehicle antenna apparatus according to claim 1, wherein at least one of the antennas is an array antenna, and a beam-forming network which forms an optional antenna beam through the array antenna and a CPU which controls the beam-forming network and the processing circuits are included.

18. The vehicle antenna apparatus according to claim 16, further comprising a memory storing the information for the above control by the CPU.

19. The vehicle antenna apparatus according to claim 1, wherein the antennas are provided on the same first substrate.

20. The vehicle antenna apparatus according to claim 1, wherein the antennas are provided on the same first substrate and the processing circuits and a unit which performs the above coupling or distribute are provided on the first substrate or a second substrate different from the first substrate.
